(19) United States
(12) Patent Application Publication
(10) Pub. No.: US 2006/0117879 A1
(43) Pub. Date: Jun. 8, 2006

(54) Motion transmission gear structure

(76) Inventor: Martin Ganser, Weil der Stadt (DE)

Correspondence Address: KLAUS J. BACH, 4407 TWIN OAKS DRIVE, MURRYSVILLE, PA, 15668, US

(21) Appl. No.: 11/305,882

(22) Filed: Dec. 16, 2005

Related U.S. Application Data
(63) Continuation-in-part of application No. PCT/EP04/06364, filed on Jun. 12, 2003.

(30) Foreign Application Priority Data
Jun. 18, 2003 (DE) 103 27 440.5

(51) Int. Cl. F16H 21/12

(52) U.S. Cl. 74/63

(57) ABSTRACT

In a device for transmitting rotational movement including an input shaft, which is connected to an input element and an output shaft which is operatively connected to the input shaft by means of a gearing structure, the gearing structure has a transmission element in the shape of a sphere and the axes of the input and output shafts intersect at the center point of the transmission element.

This is a Continuation-in-Part Application of International Application PCT/EP2004/006364 filed Jun. 12, 2004 and claiming the priority of German application 103 27 440.5 filed Jun. 18, 2003.

### BACKGROUND OF THE INVENTION

The invention relates to a motion transmission gear structure, particularly for a vehicle steering gear or a windshield wiper drive including input and output shafts interconnected by a gear structure INCLUDING a curved motion transfer element.

A motion transmission gear structure of this type is known for example in the form of a steering gear from U.S. Pat. No. 1,814,988. Connected to the input shaft is an elliptical transmission element which has control grooves in which a control finger is received, which control finger is connected by means of an output lever to an output shaft. The pivoting angle of the output shaft, however, is small.

A mechanism for transmitting motion is also known from FR 799 517. In this case, a spherical transmission element having control grooves is partially enclosed by a cylindrical output shaft, a control finger being received in the grooves of THE transmission element.

It is the object of the present invention to provide a gearing structure vehicle which forms a drive with a relatively large a pivoting angle of the output shaft.

### SUMMARY OF THE INVENTION

In a device for transmitting rotational movement including an input shaft, which is connected to an input element and an output shaft which is operatively connected to the input shaft by means of a gearing structure, the gearing structure has a transmission element in the shape of a sphere and the axes of the input and output shafts intersect at the center point of the transmission element.

A vehicle gearing structure according to the invention has a transmission element whose basic form is in the shape of a sphere, ellipse or hyperboloid of revolution. The transmission element may for example be designed as a sphere, as a hyperboloid of revolution, as an ellipsoid or as an elliptical swash plate. An efficient, cost-effective gear structure can be provided in this manner because simple gearing arrangements may thus be realized. In this case, for example, no components with complex internal machining are required.

In addition, the transmission element has a control groove in which a control finger is received, which control finger is connected by means of an output lever to the output shaft. Alternatively, the control finger may be represented by a rolling element which rolls in the control groove. In this case, the rolling element is connected to the output shaft by means of a bearing. On account of the spherical or elliptical basic form of the transmission element, constant engagement of the control finger in the control groove is ensured. In this case, an elliptical transmission element is used if an offset is required between the input and output shafts.

According to the invention, for a sphere the longitudinal axes of the input and output shafts intersect at the central point of the transmission element and the longitudinal axis of the control finger lies in a plane with the longitudinal axis of the input shaft.

In a further embodiment of the invention, the control groove is arranged in annular or helical form on the surface or in the body of the transmission element. In the case of a helical arrangement, the control groove is arranged so as to be inclined with respect to the longitudinal axis of the input shaft. The closed ring has the effect that, in one rotation of the input shaft, the output shaft is pivoted a maximum of once in one direction and then back again. In this case, the magnitude of the pivoting and hence the transmission ratio of the gearing are dependent on the inclination of the ring with respect to the longitudinal axis of the input shaft. Gearings of this type may for example be implemented in windshield wiper drives of vehicles.

In the case of a spherical basic form of the transmission element and an annular control groove, the control finger may be realized by means of balls of a ball bearing. In this case, the inner race (the inner ring) of the ball bearing is formed by the control groove or the inner race is attached to the control groove. The outer race (the outer ring) of the ball bearing is connected in a non-positive manner to the output shaft.

In the case of a helical arrangement of the control groove, the groove encircles the longitudinal axis of the input shaft helically, the local diameter varying as a function of the spherical or elliptical basic shape of the transmission element when progressing from one connection point of the transmission element and input shaft to the opposite connection point. In contrast to the elliptical basic shape, a hyperboloid of revolution has not a convex but a concave basic form. Gearings of this type may for example be used as a steering gear in a vehicle. In this case, the transmission ratio of the gearing is established by means of the length and hence the number of turns of the control groove.

In a further embodiment, the helical control groove has a different pitch, at least in segments. In this way, a variable ratio between the input and output shafts can be realized.

By way of example, the turns of the control groove in the region of greatest radial extent of the transmission element may lie closer together and thus have a lower pitch than in the end regions which are closer to the connection points of the transmission element and the input shaft.

An advantageous exemplary application of a configuration of this type is in a steering gear of a steered vehicle. In this way, small steering movements of the input shaft about a central position when driving straight ahead, in which situation the control finger runs perpendicular to the input shaft, result in only small angular changes of the output shaft, whilst larger steering movements, by means of a larger steering input at a steering handle which is connected to the input shaft, cause a more pronounced steering movement at the output shaft. This is particularly advantageous in applications in various driving situations. Small steering movements at high speed, for example when driving on a freeway, should effect small changes in the direction of travel. In the case of low speed or parking maneuvers, in which large steering angle changes are regularly required, an increase in ratio at large steering angles has the effect that a driver need only apply a small number of rotations to the input shaft by means of the steering wheel in order to turn the steerable vehicle wheels suitably sharply.

In a further embodiment, an actuating device such as an actuating motor is present, by means of which the position of the control finger relative to the output lever may be varied. A pivoting of the control finger effects a pivoting movement of the output lever and hence a pivoting of the output shaft connected to the output lever. Since a pivoting of the control finger independently of a rotational movement of the input shaft causes a pivoting movement of the output shaft, superposition of a pivoting movement may thus be generated.

The use of the device according to the invention as a steering gear of a vehicle thus permits a superposition gearing to be realized, by means of which a steering intervention can be realized in order to influence the driving behavior of the vehicle. By way of example, a steering angle which increases driving stability may be applied to the steered vehicle wheels by means of the steering gear, which is connected to the steerable vehicle wheels by means of a steering linkage, if a controller detects an unstable driving situation. A steering angle which for example increases the agility of the vehicle may likewise be applied.

In a further embodiment of the invention, the control groove has a curved cross section, at least in segments. The curved segment, is particularly in the form of a circle, such that when the control finger is engaged in the control groove, the longitudinal axis of said control finger runs perpendicular to the surface of the control groove at all times, independently of the degree of pivoting of the control finger.

In a further embodiment, the transmission element is hollow and/or has a porous surface. In this way, for example, a lightweight gearing can be realized. The required stiffness for transmitting steering moments from the input shaft to the output shaft may, if appropriate, be achieved in this case by means of struts running within the hollow space of the transmission element. The transmission element may also be formed solely by the circumferential control groove and connections running between the turns.

The invention is described in more detail below with reference to the accompanying drawings:

### BRIEF DESCRIPTION OF THE DRAWINGS

FIG. 1 is a plan view of a schematically illustrated embodiment of a device according to the invention,

FIG. 2 is a side view of an embodiment according to FIG. 1,

FIG. 3 is a side view, rotated through 90° relative to FIG. 2, of a further embodiment having an actuating device on the output lever, with a control finger in a central position, and

FIG. 4: is a detail view of a cross section of a groove in the transmission element.

### DESCRIPTION OF PREFERRED EMBODIMENTS

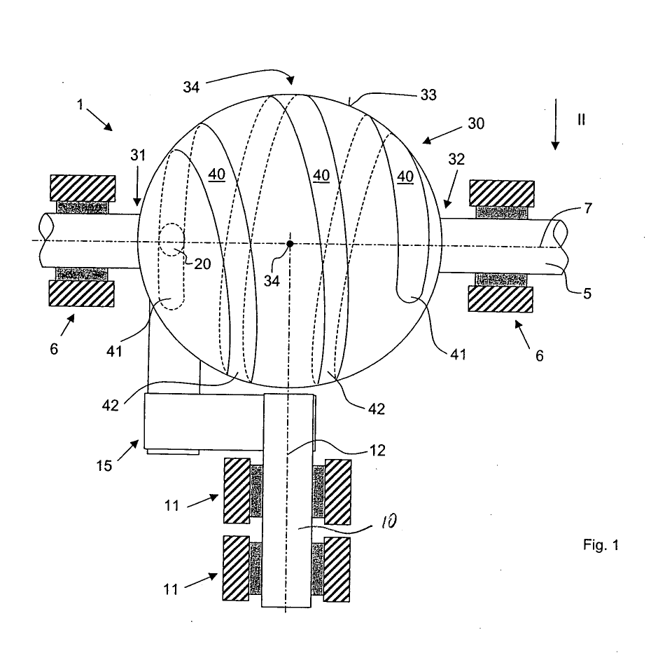

FIG. 1 shows in principle the device 1 according to the invention in a plan view. An input shaft 5 is rotatably supported at two bearing points 6. Between the bearing points 6, a spherical transmission element 30 is connected in a non-positive manner to the input shaft 5 at two connection points 31, 32. A control groove 40 is incorporated in the surface 33 of the transmission element 30, which control groove extends helically along the surface of the sphere 33, around a longitudinal axis 7 of the input shaft 5, between two stops 41.

In FIG. 1, the turns 42 of the control groove 40 have a constant pitch. It is however also possible to provide segments of a control groove 40 with a different pitch, particularly to provide a small pitch in the region of the center of the sphere 34 and a larger pitch in the regions adjacent the connection points 31, 32.

An output shaft 10 is arranged substantially orthogonally with respect to the longitudinal axis 7 of the input shaft 5 and is pivotably mounted at two bearing points 11. The output shaft 10 is in this case arranged relative to the input shaft 5 in such a way that the respective longitudinal axes 7, 12 of the two shafts 5, 10 intersect at the central point 34 of the spherical transmission element 30.

An output lever 15 in the form of an angular arm is connected in a non-positive manner to an end of the output shaft 10 adjacent the transmission element 30. A control finger 20, which projects into the control groove 40, is arranged at an end of the output lever 10 adjacent the transmission element 30. In FIG. 1, the control finger 20 is only illustrated by a dashed line since it is arranged behind the transmission element 30 and is hidden by the latter. In a further embodiment, the output lever 15 may be in the form of a bracket or of a half ring and may be rotatably mounted on the side of the transmission element 30 adjacent the output shaft 10.

The output lever 15 may however also have a second arm which, together with the previously mentioned first arm of the output lever 15, forms a claw. In this case, a control finger 20 is likewise arranged at that end of the second arm which faces toward the transmission element 30, which control finger extends into the control groove 40. In the position illustrated in FIG. 1, the engagement in the control groove 40 would take place in the vicinity of the right-hand stop 41 of the control groove 40. A claw design of this type requires that the pitch of the control groove 40 along the longitudinal axis 7 of the input shaft 5 is designed to be point-symmetric about the central point 34 of the spherical transmission element 30.

The invention is however not restricted to a symmetric embodiment of this type. An asymmetry may in fact be present in the pitch of the control groove 40, for example between the left and right halves of the transmission element 30 illustrated in FIG. 1. In a practical sense, only one arm of the output lever 15 would be present in this case in order to be able to guide just one control finger 20 in the control groove 40 without adverse loadings occurring. Unequal step-up and step-down transmission between the input and output shafts 5, 10, starting from a central position of the control finger 20 and depending on the rotational direction of the input shaft 5, may be achieved by means of an asymmetry of this type.

It may easily be comprehended that the arm or arms of the output lever 15 may also be of curved design, for example so as to be equidistant from the surface 33 of the spherical transmission element 30.

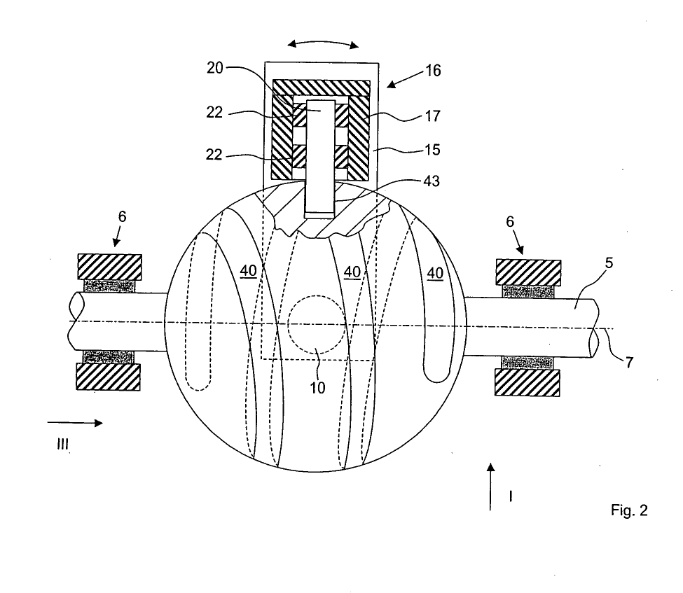

FIG. 2 shows an illustration rotated about 90° relative to FIG. 1. The output shaft 10 extends behind the drawing plane and is therefore only illustrated by a dashed line. In contrast to FIG. 1, the output lever 15 in FIG. 2 is illustrated in a central position in which it extends approximately orthogonally with respect to the longitudinal axis 7 of the input shaft 5.

In FIG. 2, the control groove 40 has an inconstant pitch. The control finger 20 can be seen which is rotatably mounted on the output lever 15. For this purpose, the control finger 20 is supported by means of two bearings 22 in the housing 17 of a guide unit 16 which is connected to the output lever 15. The bearings 22 may in this case be roller or needle bearings. The control finger 20 may roll on a side wall 43 of the control groove 40 by means of the rotatable mounting of the control finger 20. As a result, static and dynamic friction is reduced between the control finger 20 engaging in the control groove 40 and the side wall 43 of the control groove 40.

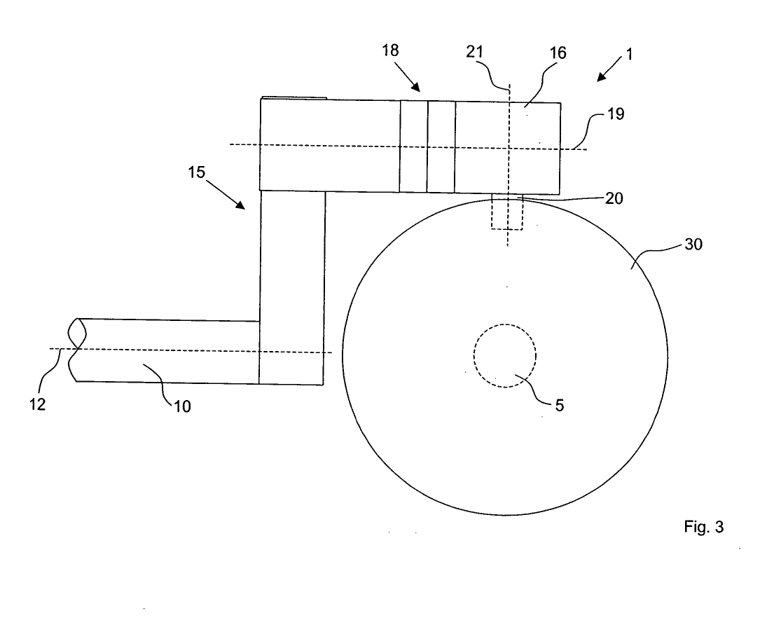

FIG. 3 illustrates the device 1 according to the invention in a side view. An actuating device 18, for example an electric actuating motor, is arranged between the guide unit 16 and the output lever 15, by means of which actuating device the position of the guide unit 16, and thus of the longitudinal axis 21 of the control finger 20, relative to the output lever 15 may be varied. If the guide unit 16 is pivoted about the longitudinal axis 19 of the actuating device 18 then the longitudinal axis. 21 of the control finger 20 no longer runs orthogonally with respect to the output shaft 10 longitudinal axis 12 and no longer intersects the latter.

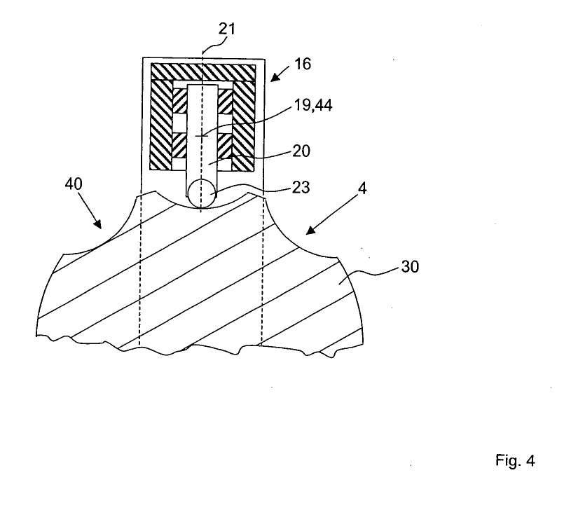

Such a pivoted position of the control finger 20 is illustrated in FIG. 4, only a segment of the transmission element 30 being illustrated in section. The cross-sectional contour of the control groove 40 may be clearly seen which is in the form of a curve, particularly a circular segment. The central point 44 of the circular segment is in this case formed by the longitudinal axis 19 of the actuating device. 18. A sphere 23 may be mounted at the end of the control finger 20 adjacent the transmission unit 30, by means of which sphere the friction between the control finger 20 and the control groove 40 may be reduced.

A pivoting of the longitudinal axis 21 of the control finger 20 causes a pivoting movement of the guide unit 16, as a result of which a pivoting movement of the output shaft 10 is achieved by means of the output lever 15. An additional pivoting angle of the output shaft 10 may thus be achieved by controlling the pivoting motor 18. Said additional pivoting angle is superposed on a pivoting angle generated by the transmission element 30 in the event of rotation of the input shaft 5. As a result, the pivoting angle of the output shaft 10 may be greater or smaller than a pivoting angle caused by the pitch of the control groove 40 of the transmission element 30 in a gearing without a pivoting motor 18.

The input shaft 5 and the output shaft 10 may be supported at the bearing points 6, 11 on a housing in which the gear structure is disposed.

What is claimed is:

1. A motion transmission structure having
an input shaft (5) which is connected to a transmission element (30) and
an output shaft (10) which is operatively connected to the input shaft (5) by means of the transmission element (30) whose basic shape is that of a sphere,
the transmission element (30) having a control groove (40) in which a control finger (20) is received, said control finger (20) being connected to the output shaft (10) by way of an output lever (15),
the input and output shafts (5, 10) having axes (7, 12) which intersect at the center point (34) of the transmission element (30) and the axis of the control finger (20) being disposed in a plane receiving the axis of the output shaft (10).

2. The motion transmission structure as claimed in claim 1, wherein the control groove (40) is arranged in a helical form on the surface (33) or in the body of the transmission element (30).

3. The motion transmission structure as claimed in claim 2, wherein the helical control groove (40) has a different pitch, at least in segments.

4. The motion transmission structure as claimed in claim 1, wherein an actuating device (19) is present, by means of which the position of the control finger (20) relative to the output lever (15) may be varied.

5. The motion transmission structure as claimed in claim 1, wherein the control groove (40) has a curved cross section, at least in segments thereof.

6. The motion transmission structure as claimed in claim 1, wherein the transmission element (30) is predominantly hollow and/or has a porous surface area (33).

7. The use of a motion transmission structure as claimed in claim 1 as a steering gear for a motor vehicle.

8. The use of motion transmission structure as claimed in claim 1 in a windshield wiper drive.
